(19) United States
(12) Patent Application Publication
(10) Pub. No.: US 2010/0016162 A1
(43) Pub. Date: Jan. 21, 2010

(54) FOLIARLY APPLICABLE SILICON NUTRITION COMPOSITIONS & METHODS

(76) Inventor: Brian Goodwin, Germantown, TN (US)

Correspondence Address: HARNESS, DICKEY, & PIERCE, P.L.C, 7700 Bonhomme, Suite 400, ST. LOUIS, MO, 63105, US

(21) Appl. No.: 12/500,779

(22) Filed: Jul. 10, 2009

Related U.S. Application Data
(60) Provisional application No. 61/080,019, filed on Jul. 11, 2008.

(51) Int. Cl. A01N 59/00; A01P 21/00

(52) U.S. Cl. 504/187

(57) ABSTRACT

A foliarly applicable plant nutrient composition comprises, in aqueous solution, (a) a first component comprising an agriculturally acceptable source of foliarly absorbable silicon; (b) a second component selected from agriculturally acceptable sources of thiosulfate ions, agents effective to inhibit polymerization of silicic acid or silicate ions, and mixtures thereof; and (c) as a third component, an agriculturally acceptable mixture of compounds selected from the group consisting of organic acids, organic compounds having funtional groups capable of reversibly binding or complexing with inorganic anions, and mixtures thereof. The composition is useful for silicon nutrition of a plant and for reducing susceptibility of a plant to fungal or bacterial disease.

This application claims the benefit of U.S. provisional application Ser. No. 61/080,019 filed on Jul. 11, 2008, the disclosure of which is incorporated by reference herein in its entirety.

### FIELD OF THE INVENTION

The present invention relates to foliarly applicable plant silicon nutrient compositions, to methods for silicon nutrition of a plant and to methods for reducing susceptibility of a plant to fungal or bacterial disease.

### BACKGROUND OF THE INVENTION

Silicon has been described as a non-essential plant nutrient which performs useful functions including improving disease resistance in plants. See, for example, Forbes & Watson (1992) Plants in Agriculture, Cambridge University Press, p. 62.

Without being bound by theory, it is believed that improved disease resistance may be associated with accumulation of silica in epidermal tissue of the plant and/or with availability of silicon in mobile form in plant tissues. Plant roots have been described as absorbing silicon from soil in the form of monosilicic acid, Si(OH)₄, sometimes written SiO₂.2H₂O, or its monovalent silicate anion, Si(OH)₃O⁻. Absorbed monosilicic acid is believed to polymerize to form polysilicic acid which is transformed into a deposit of amorphous silica in cell walls, forming a thickened silicon-cellulose membrane. See Barker & Pilbeam (2006) Handbook of Plant Nutrition, CRC Press, Boca Raton, Fla., pp. 553-554.

Mitani et al. (2005) Plant Cell Physiol. 46:279-283 have reported that, at least in rice, silicon is not only absorbed by the root but also transported to the shoot via the xylem in the form of undissociated monosilicic acid. They state that concentration of monosilicic acid in the xylem can be, at least transiently, much higher than its generally accepted limit of solubility (about 2 mM) in water.

The form or forms in which silicon is absorbable through foliar surfaces are not definitely known. However, it is believed without being bound by theory that only non-polymerized forms of silicic acid or silicate ion can enter the plant through leaf surfaces and translocate to a point of deposition. Furthermore, in providing a silicon-containing foliar fertilizer whether as an aqueous concentrate for dilution in water or as a ready-to-use application solution, the silicon should be in water-soluble form, generally ruling out highly polymerized silicic acid or silicate. Only a limited selection of silicon sources are water-soluble and suitable for use in aqueous silicon foliar nutrition compositions.

U.S. Pat. No. 5,183,477 to Masuda relates to a foliarly sprayable composition containing an alkali metal silicate, for example a sodium or potassium silicate, as a silicon source. Possible silicon sources are said to include Na₂SiO₃, Na₄SiO₄, Na₂Si₂O₅, Na₂Si₄O₄, K₂SiO₃, KHSi₂O₅ and K₂Si₄O₂.H₂O. The composition when sprayed on plant foliage is said to protect plants from disease injury.

Turgor® silicon-based nutrient of Floratine, Collierville, Tenn. is a composition including potassium silicate and potassium thiosulfate, described at www.floridaturfsupport.com/floratine/Turgor.pdf to be suitable for either foliar or soil application to turfgrass and to provide strengthened cellular structure and tissue, leaf erectness (turgidity), improved mowing cut, disease resistance, wear tolerance, salt tolerance, toxic metal buffering, and increased photosynthetic activity. An initial foliar application rate of 12-18 l/ha, followed by continuing applications at 5-13 l/ha every 7-21 days, is recommended, diluted in a spray volume not greater than 40 U.S. gallons/acre (˜340 l/ha).

Various mixtures of organic compounds have been proposed in the art as fertilizer additives. Specifically, a humic acid composition, Bio-Liquid Complex™, is stated by Bio Ag Technologies International (1999) www.phelpstek.com/portfolio/humic_acid.pdf to assist in transferring micronutrients, more specifically cationic nutrients, from soil to plant.

TriFlex™ Bloom Formula nutrient composition of American Agritech is described as containing “phosphoric acid, potassium phosphate, magnesium sulfate, potassium sulate, potassium silicate [and] sodium silicate.” TriFlex™ Grow Formula 2-4-1 nutrient composition of American Agritech is described as containing “potassium nitrate, magnesium nitrate, ammonium nitrate, potassium phosphate, potassium sulfate, magnesium sulfate, potassium silicate [and] sodium silicate.” Both compositions are said to be “fortified with selected vitamins, botanical tissue culture ingredients, essential amino acids, seaweed, humic acid, fulvic acid and carbohydrates.” See www.horticulturesource.com/product_info.php/products_id/82. These products are said to be formulated primarily for “soilless hydrogardening” (i.e., hydroponic cultivation) of fruit and flower crops, but are also said to outperform conventional chemical fertilizers in container soil gardens. Their suitability or otherwise for foliar application as opposed to application to the hydroponic or soil growing medium is not mentioned. See www.americanagritech.com/product/product_detail.asp?ID=1&pro_id_pk=40.

U.S. Pat. No. 5,250,500 to Jones & Gates describes herbicidal spray compositions comprising a foliar-applied herbicide and tetrapotassium pyrophosphate (TKPP) as a spray adjuvant.

Especially in view of the limited range of water-soluble forms of silicon, the tendency for even water-soluble forms to polymerize and become unavailable for foliar absorption, and inefficiencies in transport of silicon within plants, it would be desirable to have additional options for silicon nutrition of plants, especially food crops such as fruit and vegetable crops. It would be especially beneficial if such additional options were capable of being foliarly administered to a plant in a way that would increase disease resistance.

### SUMMARY OF THE INVENTION

There is now provided a foliarly applicable plant nutrient composition comprising, in aqueous solution,
(a) a first component comprising an agriculturally acceptable source of foliarly absorbable silicon;
(b) a second component selected from agriculturally acceptable sources of thiosulfate ions, agents effective to inhibit polymerization of silicic acid or silicate ions, and mixtures thereof; and
(c) as a third component, an agriculturally acceptable mixture of compounds selected from the group consisting of organic acids, organic compounds having functional groups capable of reversibly binding or complexing with inorganic anions, and mixtures thereof.

There is further provided a method for silicon nutrition of a plant, comprising applying such a composition to a foliar surface of the plant.

There is still further provided a method for reducing susceptibility of a plant to fungal or bacterial disease, comprising applying such a composition to a foliar surface of the plant.

According to either of the above methods, the plant is in one embodiment a food crop, for example a non-gramineous food crop such as a fruit or vegetable crop.

### BRIEF DESCRIPTION OF THE DRAWINGS

FIG. 1 is a histogram of Si content in rice leaf tissue following foliar spraying with compositions A-E as described in Example 1.

FIG. 2 is a histogram of Si content in rice leaf tissue following foliar spraying once with compositions A-E as described in Example 2.

FIG. 3 is a histogram of Si content in rice leaf tissue following foliar spraying twice with compositions A-E as described in Example 2.

FIG. 4 is a histogram of Si content in rice leaf tissue following foliar spraying with compositions A-F as described in Example 3.

FIG. 5 is a histogram of AUBSPC (area under brown spot progress curve) following inoculation with Bipolaris oryzae and foliar spraying with compositions A-F as described in Example 3.

### DETAILED DESCRIPTION

This invention is directed, in part, to plant nutrient compositions comprising at least three components, as outlined above. Compositions of the invention vary depending on the intended method of application, the plant species to which they are to be applied, growing conditions of the plants and other factors.

Compositions of the invention take the form of aqueous solutions. Each of the three recited components is present in solution in an aqueous medium. Small amounts of insoluble material can optionally be present, for example in suspension in the medium, but it is generally preferred to minimize the presence of such insoluble material.

The term “agriculturally acceptable” applied to a material herein means not unacceptably damaging or toxic to a plant or its environment, and not unsafe to the user or others that may be exposed to the material when used as described herein.

The first of the three recited components is a source of foliarly absorbable silicon. Such a source includes any compound or mixture of compounds which can, at least under optimum conditions, provide silicon in a form that can be absorbed by a plant from a foliar surface thereof.

The term “silicate ion” herein means any anionic form of silicon. Silicate ions comprise one or more central silicon atoms surrounded by electronegative oxygen atoms. Typically, silicate ions that comprise up to three silicon atoms are water-soluble. Silicate ions preferred herein have one or two, most preferably only one, silicon atom.

Silicon can be absorbed by plant leaves in various forms, but it is believed, without being bound by theory, to be predominantly absorbed as monosilicic acid, Si(OH)₄, or its monovalent anion, Si(OH)₃O⁻. Si(OH)₄ and its anion Si(OH)₃O⁻ exist in aqueous solution in an equilibrium, which is primarily pH-driven. At a high pH, for example a pH greater than about 9.0, monosilicic acid is predominantly dissociated and present as the Si(OH)₃O⁻ anion.

In some embodiments, the composition has an alkaline pH, for example a pH of at least about 7.0, for example at least about 7.5, at least about 8.0, at least about 8.5, at least about 9.0, at least about 9.5, at least about 10.0, at least about 10.5, or at least about 11.0, to maintain silicate in substantially dissociated, more soluble, form.

A suitable source of foliarly absorbable silicon comprises an electrically neutral compound which includes at least one positively charged cation associated with at least one negatively charged silicate anion having no more than three, preferably no more than two, most preferably only one, silicon atom. An example of such a source is a water-soluble alkali metal silicate salt, for example potassium silicate or sodium silicate. More than one such salt can optionally be present. It is generally advantageous to use potassium silicate, as the potassium as well as the silicate ion is nutritionally useful to the plant. Potassium silicate is commercially available in agriculturally acceptable form, for example as a concentrated aqueous solution from PQ Corp. under the tradename AgSil®. According to the supplier's website, AgSil® 21 and AgSil® 25 have a pH of 11.7 and 11.3 respectively. See www.pqcorp.com/literature/report_{—}24.pdf.

The second of the three recited components is selected from agriculturally acceptable sources of thiosulfate ions, agents effective to inhibit polymerization of silicic acid or silicate ions, and mixtures thereof. The categories of (a) thiosulfate sources and (b) silicic acid or silicate polymerization inhibitors are not mutually exclusive.

In some embodiments, the second component comprises a water-soluble source of thiosulfate ions (S₂O₃²⁻), for example ammonium thiosulfate, sodium thiosulfate or potassium thiosulfate. It is generally advantageous to use potassium thiosulfate (K₂S₂O₃), as the potassium as well as sulfur from the thiosulfate ion is nutritionally useful to the plant.

It is believed, without being bound by theory, that the thiosulfate ion acts to inhibit polymerization of silicate ions or silicic acid. It is further believed, again without being bound by theory, that this inhibition of polymerization can help keep the Si nutrient mobile in plant tissues for a longer period of time. However, use of a source of thiosulfate ions as the second component is not predicated on such a mode of action. Thus, the source of thiosulfate ions can be, but is not necessarily, a silicate polymerization inhibitor.

Many factors affect the degree of polymerization of silicic acid or silicate ions in solution. Some such factors include silicic acid or silicate concentration, temperature, pH and presence of other ions, small molecules and polymers.

The term “silicic acid” refers to a group of compounds consisting of silicon, hydrogen and oxygen atoms. Simple silicic acids include metasilicic acid (H₂SiO₃), orthosilicic acid (H₄SiO₄), disilicic acid (H₂Si₂O₅) and pyrosilicic acid (H₆Si₂O₇). Under certain conditions, these silicic acids condense to form polymeric silicic acids of complex structure. The polymerization product is often referred to generally as silica gel (SiO₂.nH₂O).

Generally, as alkali metal silicate solutions are diluted, pH becomes lower and silicic acids hydrolyze to form larger polymeric species. Because pH affects the degree of ionization of silanol groups (—OH groups bonded directly to silicon), it also affects the polymerization rate. Generally, as the pH of a silicate solution decreases, the rate of polymerization increases.

Accordingly, in some embodiments, the second component comprises an alkaline agent effective to inhibit polymerization of silicic acid or silicate ions. Such an agent can be present in an amount such that the composition as a whole has a pH of at least about 7.0, for example at least about 7.5, at least about 8.0, at least about 8.5, at least about 9.0, at least about 9.5, at least about 10.0, at least about 10.5, or at least about 11.0.

The third of the three recited components is an agriculturally acceptable mixture of compounds selected from the group consisting of organic acids, organic compounds having functional groups capable of reversibly binding or complexing with inorganic anions, and mixtures thereof. The categories of (a) organic acids and (b) organic compounds having functional groups capable of reversibly binding or complexing with inorganic anions are not mutually exclusive, as certain organic acids themselves have functional groups capable of reversibly binding or complexing with inorganic anions.

The term “organic acid” herein means an organic compound with acidic properties. Common organic acids comprise carboxylic acids, whose acidity is associated with one or more carboxyl (—COOH) groups. Other groups which can confer acidity include —OSO₃H, —OH, —SH, enol and phenol groups. In some embodiments, the mixture of compounds includes one or more organic acids selected from humic acids, fulvic acids, polyhydroxycarboxylic acids, amino acids and mixtures thereof.

In some embodiments, the mixture of compounds comprises humic substances. The term “humic substances” herein refers to organic compounds isolated and extracted in an aqueous solution from sources rich in organic matter. Humic substances include extracts of organic matter formed by the process of humification, involving microbial degradation of plant and animal matter, and include extracts of ancient organic deposits such as leonardite. For the purposes of the present invention, however, the term “humic substances” expressly includes compounds extracted from organic matter that has not undergone humification, or that is only partially humified. Humic substances typically consist of a heterogeneous mixture of compounds for which no single structural formula will suffice. Common examples of humic substances include humic and fulvic acids.

Humic and fulvic acids are supramolecular aggregates and are often characterized and/or classified based on their color, degree of polymerization, molecular weight, carbon content, oxygen content and solubility in water. Generally, fulvic acids are light yellow or light brown, while humic acids are dark brown or grey-black in color. Aggregates classified as fulvic acids have lower molecular weight than those classified as humic acids, although there is no precise molecular weight cut-off for these categories. It will be understood that with respect to compounds such as humic and fulvic acids that are aggregates of smaller molecules, molecular weights herein apply to the supramolecular aggregates, not to their smaller molecular substructures.

Further, humic and fulvic acids can be defined by their solubility in solutions of varying pH. The term “humic acid” means a fraction of humic substances that is not soluble in water under acidic conditions (pH<2) but is soluble at higher pH. Humic acids are the major extractable component of soil humic substances. The term “fulvic acid” means a fraction of humic substances that is soluble in water under all pH conditions. Fulvic acids often remain in solution after removal of humic acids by acidification. Humic and fulvic acids each exhibit both aliphatic and aromatic characteristics.

Substances able to reversibly bind or complex with inorganic ions are useful in plant nutrition. Without being bound by theory, it is believed the ability of a composition to complex ions assists in plant nutrition by facilitating uptake and/or translocation of ions in the plant. This may occur through preferential movement of ions via the xylem or phloem to the growing and fruiting points of the plant. Inorganic ions can be positively charged cations or negatively charged anions. Examples of inorganic cations include Mg²⁺, Ca²⁺, Fe²⁺ and Fe³⁺. Examples of inorganic anions include borate and silicate. Such reversible binding or complexing may take the form of chelation.

Humic and fulvic acids are very effective chelators of multivalent cations, including some that are important plant nutrients, but they have not been associated in the art with improved absorption of anionic species such as silicate ions. Without being bound by theory, it is believed that, in the present composition, a third component that consists only of humic and/or fulvic acids can be effective, but less so than a third component having at least one anion-complexing agent in place of or in addition to humic and/or fulvic acids.

Accordingly, in some embodiments, the third component comprises one or more organic compounds having functional groups capable of reversibly binding or complexing with inorganic anions. An ability to reversibly bind or complex with anions has been associated with amino functional groups, as occur for example in polyamines and amino acids. However, the present invention embraces compositions wherein the third component comprises organic compounds having any functional group or combination of functional groups that exhibit ability to reversibly bind or complex with inorganic anions.

In a particular embodiment, the third component comprises organic acids which have the ability to reversibly bind or complex with both inorganic anions and inorganic cations.

The organic compounds making up the third component can be characterized in a variety of ways (e.g., by molecular weight, distribution of carbon among different functional groups, relative elemental composition, amino acid content, carbohydrate content, etc.).

In some embodiments, the mixture of compounds comprises organic molecules or supramolecular aggregates with a molecular weight distribution of about 300 to about 30,000 daltons, for example, about 300 to about 25,000 daltons, about 300 to about 20,000 daltons, or about 300 to about 18,000 daltons.

For purposes of characterizing carbon distribution among different functional groups, suitable techniques include without limitation ¹³C-NMR, elemental analysis, Fourier transform ion cyclotron resonance mass spectroscopy (FTICR-MS) and Fourier transform infrared spectroscopy (FTIR).

In one embodiment, carboxy and carbonyl groups together account for about 25% to about 40%, for example about 30% to about 37%, illustratively about 35%, of carbon atoms in the mixture of organic compounds.

In one embodiment, aromatic groups account for about 20% to about 45%, for example about 25% to about 40% or about 27% to about 35%, illustratively about 30%, of carbon atoms in the mixture of organic compounds.

In one embodiment, aliphatic groups account for about 10% to about 30%, for example about 13% to about 26% or about 15% to about 22%, illustratively about 18%, of carbon atoms in the mixture of organic compounds.

In one embodiment, acetal and other heteroaliphatic groups account for about 10% to about 30%, for example about 13% to about 26% or about 15% to about 22%, illustratively about 19%, of carbon atoms in the mixture of organic compounds.

In one embodiment, the ratio of aromatic to aliphatic carbon is about 2:3 to about 4:1, forexample about 1:1 to about 3:1 orabout 3:2 toabout 2:1.

In a particular illustrative embodiment, carbon distribution in the mixture of organic compounds is as follows: carboxy and carbonyl groups, about 35%; aromatic groups, about 30%; aliphatic groups, about 18%, acetal groups, about 7%; and other heteroaliphatic groups, about 12%.

Elemental composition of the organic compounds of the third component is independently in one series of embodiments as follows, by weight: C, about 28% to about 55%, illustratively about 38%; H, about 3% to about 5%, illustratively about 4%; O, about 30% to about 50%, illustratively about 40%; N, about 0.2% to about 3%, illustratively about 1.5%; S, about 0.2% to about 4%, illustratively about 2%.

Elemental composition of the organic compounds of the third component is independently in another series of embodiments as follows, by weight: C, about 45% to about 55%, illustratively about 50%; H, about 3% to about 5%, illustratively about 4%; O, about 40% to about 50%, illustratively about 45%; N, about 0.2% to about 1%, illustratively about 0.5%; S, about 0.2% to about 0.7%, illustratively about 0.4%.

In a particular illustrative embodiment, elemental distribution is, by weight: C, about 38%; H, about 4%; O, about 40%; N, about 1.5%; and S, about 2%. The balance consists mainly of inorganic ions, principally potassium and iron.

In another particular illustrative embodiment, elemental distribution is, by weight: C, about 50%; H, about 4%; O, about 45%; N, about 0.5%; and S, about 0.4%.

Among classes of organic compounds that can be present in the third component are, in various embodiments, amino acids, carbohydrates (monosaccharides, disaccharides and polysaccharides), sugar alcohols, carbonyl compounds, polyamines and mixtures thereof.

Examples of amino acids that can be present include without limitation arginine, aspartic acid, glutamic acid, glycine, histidine, isoleucine, serine, threonine, tyrosine and valine.

Examples of monosaccharide and disaccharide sugars that can be present include without limitation glucose, galactose, mannose, fructose, arabinose, ribose and xylose.

In a particular embodiment, the third component comprises a mixture of organic molecules isolated and extracted in an aqueous solution from sources rich in organic matter. The mixture consists of relatively small molecules or supramolecular aggregates with a molecular weight distribution of about 300 to about 18,000 daltons. Included in the organic matter from which the mixture of organic molecules are fractionated are various humic substances, organic acids and microbial exudates. Like most humic substances, the mixture is shown to have both aliphatic and aromatic characteristics. Illustratively, the carbon distribution shows about 35% in carbonyl and carboxyl groups; about 30% in aromatic groups; about 18% in aliphatic groups, about 7% in acetal groups; and about 12% in other heteroaliphatic groups.

A suitable mixture of organic compounds can be found in products marketed as Carbon Boost™-S soil solution and KAFÉ™-F foliar solution of Floratine Biosciences, Inc. (FBS). Information on these products is available at www.fbsciences.com. Thus exemplary compositions of the present invention can be prepared by adding potassium silicate as the first component, potassium thiosulfate as the second component and Carbon Boost™-S or KAFÉ™-F foliar solution as the third component, to a suitable volume of water.

The amount of the third component that should be present in the composition depends on the particular organic mixture used. The amount should not be so great as to result in a physically unstable composition, for example by exceeding the limit of solubility of the mixture in the composition, or by causing other essential components to fall out of solution. On the other hand, the amount should not be so little as to fail to provide enhanced silicon nutrition or enhanced disease protection when applied to a target plant species. For any particular organic mixture, one of skill in the art can, by routine formulation stability and bioefficacy testing, optimize the amount of organic mixture in the composition for any particular use.

Particularly where a mixture of organic compounds as found, for example, in Carbon Boost™-S and KAFÉ™-F solutions is used, the amount needed in a silicon nutrition composition of the invention will often be found to be remarkably small. For example, as little as one part by weight (excluding water) of such a mixture can, in some circumstances, assist in foliar delivery of up to about 1000 or more parts by weight Si to a site of deposition in a plant. In other circumstances it may be found beneficial to add a greater amount of the organic mixture, based on routine testing. Typically, a suitable ratio of organic compounds to Si is about 1:2000 to about 1:5, for example about 1:1000 to about 1:10 or about 1:500 to about 1:20, illustratively about 1:100. If using Carbon Boost™-S or KAFÉ™-F solution as the source of organic compounds, a suitable amount of such solution to be included in a concentrate composition of the invention is about 1 part by weight Carbon Boost™-S or KAFÉ™-F solution in about 5 to about 25, for example about 8 to about 18, illustratively about 12, parts by weight of the concentrate composition.

Optionally, additional components can be present in a composition of the present invention together with the first, second and third components as describe above. For example, the composition can further comprise at least one agriculturally acceptable source of a plant nutrient other than silicon. (Where potassium silicate is used as the first component and a thiosulfate salt such as potassium thiosulfate is used as the second component, it will be noted that the composition already contains potassium (K) and sulfur (S). Additional sources of these nutrients can be present, if desired.) Examples of other plant nutrients, sources of which can optionally be included, are phosphorus (P), calcium (Ca), magnesium (Mg), iron (Fe), zinc (Zn), manganese (Mn), copper (Cu) and boron (B). Addition of multivalent cations such as Ca, Mg or Fe can, however, result in precipitation of insoluble silicates unless these multivalent cations are well chelated in the composition.

In one embodiment, the composition comprises a source of phosphorus. Any phosphate salt can be used, preferably a water-soluble phosphate such as tetrapotassium pyrophosphate (TKPP).

Compositions of the invention can be provided in concentrate form, suitable for further dilution in water prior to application to the plant. Alternatively, they can be provided as a ready-to-use solution for direct application to the plant. Because compositions of the invention can be combined with other fertilizer solutions and/or with pesticide solutions, they can be diluted by mixing with such other solutions.

Compositions of the invention vary in their specific nutrient content (e.g., NPK and/or Si content). The term “NPK” references a common fertilizer nomenclature scheme. Fertilizers often show their nutrient content with three bold numbers on the package, representing percentages by weight of nitrogen (as elemental N), phosphorus (as phosphate, P₂O₅) and potassium (as potash, K₂O). For example, a fertilizer composition designated as 2-4-3 contains 2% N, 4% P (as P₂O₅) and 3% K (as K₂O).

Typically the nitrogen contributed by the third component of the present compositions is in too low an amount to be registered on the NPK system. Thus compositions of the invention will often show “0” as their N content. However, if desired, a nitrogen fertilizer such as urea or an ammonium or nitrate salt can be added, for example in an amount up to about 30% N by weight.

The P (as P₂O₅) content typically is 0% to about 10%, for example about 1% to about 8%, about 3% to about 7%, or about 4% to about 6%, by weight. The P, if present, can illustratively be contributed in whole or in part by TKPP.

The K (as K₂O) content typically is about 1% to about 40%, for example about 5% to about 30%, or about 10% to about 25%, by weight. The K can illustratively be contributed by one or more of potassium silicate, potassium thiosulfate and TKPP.

The Si content typically is about 0.1% to about 10%, for example about 1% to about 8%, about 2% to about 6%, or about 3% to about 5%, elemental Si by weight.

A particular illustrative composition has an NPK designation of 0-5-18, and contains about 3.7% Si.

The above NPK and Si contents relate to concentrate compositions suitable for further dilution. For application to plant foliage, a concentrate composition can be diluted up to about 600-fold with water, more typically up to about 100-fold or up to about 40-fold. Illustratively, a concentrate product can be applied at about 1 to about 30 l/ha, for example about 5 to about 25 l/ha, in a total application volume after dilution of about 60 to about 600 l/ha, for example about 80 to about 400 l/ha or about 100 to about 200 l/ha. Illustratively, if the Si content of the concentrate product is about 1% to about 8%, such dilution can result in an application solution having a Si content of about 0.001% to about 2%, for example about 0.01% to about 1% or about 0.05% to about 0.5%. A 0-5-18 product having 3.7% Si, if diluted 15-fold (i.e., to 6.7% of its original concentration), produces an application solution containing about 0.25% Si; and if diluted 30-fold (i.e., to 3.3% of its original concentration), produces an application solution containing about 0.12% Si.

Application solutions prepared by diluting concentrate compositions as described above represent further embodiments of the present invention.

Whether in concentrate, ready-to-use or diluted compositions, suitable weight ratios of Si to K (as K₂O) illustratively range from about 1:1 to about 1:10, for example about 1:2 to about 1:8, illustratively about 1:5; and (where a phosphate source such as TKPP is present) suitable weight ratios of Si to P (as P₂O₅) illustratively range from about 5:1 to about 1:5, for example about 3:1 to about 1:3, illustratively about 1:1.

One of ordinary skill in the art will readily prepare compositions having amounts or ratios of nutrients recited above by mixing ingredients as indicated herein. Illustratively, where the first component is potassium silicate (KSiH₃O₄), the second component is potassium thiosulfate (K₂S₂O₃), the third component is an organic mixture and the composition optionally further comprises TKPP (K₄P₂O₇), an aqueous solution of the invention can be prepared using, for each part by weight KSiH₃O₄, about 0.05 to about 5, for example about 0.1 to about 3 or about 0.3 to about 1.5, parts by weight K₂S₂O₃, a suitable amount of the organic mixture as indicated elsewhere herein, and zero to about 10, for example about 0.5 to about 5 or about 1 to about 2.5, parts by weight K₄P₂O₇. These ingredients are dissolved in a volume of water sufficient to maintain them in solution. Parts by weight in the present context will be understood to exclude any diluent such as water in which the ingredients are supplied. For example, where KSiH₃O₄ is supplied as a 25% solution in water, 4 parts by weight of the solution are needed to provide 1 part by weight KSiH₃O₄.

An illustrative composition having no TKPP consists of:

potassium silicate (KSiH₃O₄): 2-20%, for example 5-20% by weight;

potassium thiosulfate (K₂S₂O₃): 1-40%, for example 2-35% or 5-20% by weight;

organic mixture: suitable amount as indicated elsewhere herein;

water: balance to 100% by weight.

An illustrative composition containing TKPP consists of:

potassium silicate (KSiH₃O₄): 2-20%, for example 5-15% by weight;

potassium thiosulfate (K₂S₂O₃): 1-25%, for example 5-20% by weight;

organic mixture: suitable amount as indicated elsewhere herein;

TKPP (K₄P₂O₇): 2-30%, for example 5-25% by weight;

water: balance to 100% by weight.

Other ingredients can optionally be present in a composition of the invention, including such conventional formulation adjuvants as surfactants (for example to enhance wetting of leaf surfaces), spray drift controlling agents, antifoam agents, viscosity modulating agents, antifreezes, coloring agents, etc. Any of these can be added if desired, so long as they do not destabilize essential components of the composition, but in general they will be found unnecessary.

Processes for preparing a composition of the invention typically involve simple admixture of the required ingredients. If desired, any of the ingredients can be pre-dissolved in a suitable volume of water before mixing with other ingredients. Order of addition is not generally critical.

Methods of use of a composition as described herein for silicon nutrition and/or for reducing susceptibility to disease of a plant are further embodiments of the present invention. The composition can be applied to a single plant (e.g., a houseplant or garden ornamental) or to an assemblage of plants occupying an area. In some embodiments, the composition is applied to an agricultural or horticultural crop, more especially a food crop. A “food crop” herein means a crop grown primarily for human consumption. Methods of the present invention are appropriate both for field use and in protected cultivation, for example, greenhouse use.

While the present methods can be beneficial for gramineous (belonging to the grass family) crops such as cereal crops, including corn, wheat, barley, oats and rice, they are also highly appropriate for non-gramineous crops, including vegetable crops, fruit crops and seed crops. The terms “fruit” and “vegetable” herein are used in their agricultural or culinary sense, not in a strict botanical sense; for example, tomatoes, cucumbers and zucchini are considered vegetables for present purposes, although botanically speaking it is the fruit of these crops that is consumed.

Vegetable crops for which the present methods can be found useful include without limitation:
leafy and salad vegetables such as amaranth, beet greens, bitterleaf, bok choy, Brussels sprout, cabbage, catsear, celtuce, choukwee, Ceylon spinach, chicory, Chinese mallow, chrysanthemum leaf, corn salad, cress, dandelion, endive, epazote, fat hen, fiddlehead, fluted pumpkin, golden samphire, Good King Henry, ice plant, jambu, kai-lan, kale, komatsuna, kuka, Lagos bologi, land cress, lettuce, lizard's tail, meloktia, mizuna greens, mustard, Chinese cabbage, New Zealand spinach, orache, pea leaf, polk, radicchio, rocket (arugula), samphire, sea beet, seakale, Sierra Leone bologi, soko, sorrel, spinach, summer purslane, Swiss chard, tatsoi, turnip greens, watercress, water spinach, winter purslane and yau choy;
flowering and fruiting vegetables such as acorn squash, Armenian cucumber, avocado, bell pepper, bitter melon, butternut squash, caigua, Cape gooseberry, cayenne pepper, chayote, chili pepper, cucumber, eggplant (aubergine), globe artichoke, luffa, Malabar gourd, parwal, pattypan squash, perennial cucumber, pumpkin, snake gourd, squash (marrow), sweetcorn, sweet pepper, tinda, tomato, tomatillo, winter melon, West Indian gherkin and zucchini (courgette);
podded vegetables (legumes) such as American groundnut, azuki bean, black bean, black-eyed pea chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean and yardlong bean;
bulb and stem vegetables such as asparagus, cardoon, celeriac, celery, elephant garlic, fennel, garlic, kohlrabi, kurrat, leek, lotus root, nopal, onion, Prussian asparagus, shallot, Welsh onion and wild leek;
root and tuber vegetables, such as ahipa, arracacha, bamboo shoot, beetroot, black cumin, burdock, broadleaf arrowhead, camas, canna, carrot, cassava, Chinese artichoke, daikon, earthnut pea, elephant-foot yam, ensete, ginger, gobo, Hamburg parsley, horseradish, Jerusalem artichoke, jicama, parsnip, pignut, plectranthus, potato, prairie turnip, radish, rutabaga (swede), salsify, scorzonera, skirret, sweet potato, taro, ti, tigernut, turnip, ulluco, wasabi, water chestnut, yacon and yam; and
herbs, such as angelica, anise, basil, bergamot, caraway, cardamom, chamomile, chives, cilantro, coriander, dill, fennel, ginseng, jasmine, lavender, lemon balm, lemon basil, lemongrass, marjoram, mint, oregano, parsley, poppy, saffron, sage, star anise, tarragon, thyme, turmeric and vanilla.

Fruit crops for which the present methods can be found useful include without limitation apple, apricot banana, blackberry, blackcurrant, blueberry, boysenberry, cantaloupe, cherry, citron, clementine, cranberry, damson, dragonfruit, fig, grape, grapefruit, greengage, gooseberry, guava, honeydew, jackfruit, key lime, kiwifruit, kumquat, lemon, lime, loganberry, longan, loquat, mandarin, mango, mangosteen, melon, muskmelon, orange, papaya, peach, pear, persimmon, pineapple, plantain, plum, pomelo, prickly pear, quince, raspberry, redcurrant, starfruit, strawberry, tangelo, tangerine, tayberry, ugli fruit and watermelon.

Seed crops for which the present methods can be found useful include, in addition to cereals (e.g., barley, corn (maize), millet, oats, rice, rye, sorghum (milo) and wheat), non-gramineous seed crops such as buckwheat, cotton, flaxseed (linseed), mustard, poppy, rapeseed (including canola), safflower, sesame and sunflower.

Other crops, not fitting any of the above categories, for which the present methods can be found useful include without limitation sugar beet, sugar cane, hops and tobacco.

Each of the crops listed above has its own particular silicon nutrition and disease protection needs. Further optimization of compositions described herein for particular crops can readily be undertaken by those of skill in the art, based on the present disclosure, without undue experimentation.

Methods of the invention comprise applying a composition as described herein to a foliar surface of a plant. A “foliar surface” herein is typically a leaf surface, but other green parts of plants have surfaces that may permit absorption of silicon, including petioles, stipules, stems, bracts, flowerbuds, etc., and for present purposes “foliar surfaces” will be understood to include surfaces of such green parts. Absorption typically occurs at the site of application on a foliar surface, but the applied composition can run down to other areas and be absorbed there. Runoff (where an applied solution is shed from foliar surfaces and reaches the soil or other growing medium of the plant) is generally undesirable, but the applied nutrient is generally not totally lost as it can be absorbed by the plant's root system. However, methods of application that minimize runoff are preferred, and are well known to those of skill in the art. They include without limitation avoiding excessive spray volume (typically spray volumes in excess of about 400 l/ha lead to substantial runoff), controlling spray droplet size (smaller droplets are more likely to be retained than larger droplets), spraying when rain or overhead irrigation is not imminent, etc.

Compositions of the invention can be applied using any conventional system for applying liquids to a foliar surface. Most commonly, application by spraying will be found most convenient, but other techniques, including application by brush or by rope-wick can be used if desired. For spraying, any conventional atomization method can be used to generate spray droplets, including hydraulic nozzles and rotating disk atomizers.

As described hereinabove, the composition applied should be dilute. If too concentrated a solution is applied directly to a foliar surface, certain plant species are susceptible to injury at the site of application, in the form of foliar “burn”. This is undesirable not only because it can adversely affect growth and yield of the plant, but also because a foliar surface injured in this way may be less capable of absorbing the applied nutrient. For most purposes a Si concentration for application should not exceed about 0.5%. A composition having higher Si concentration should generally be diluted before use. The optimum concentration of the solution to be applied depends on a number of factors, including the plant species being treated, the particular growing conditions, the particular composition being used and the benefit sought. One of skill in the art will readily optimize application concentration (or degree of dilution of a concentrate composition) without undue experimentation. However, for a concentrate composition containing about 3% to about 5% Si, satisfactory results will generally be obtained by diluting about 10 to about 200 fold (i.e., applying at a dilution of about 0.5% to about 10%), for example about 15 to about 100 fold (a dilution of about 1% to about 6.6%), illustratively a dilution of about 1%, about 1.25%, about 1.6%, about 2%, about 2.5%, about 3.3%, about 4%, about 5% or about 6.6%.

Application rate of Si can be characterized in terms of concentration in the applied solution or in terms of amount per unit area (typically land area as opposed to foliar area). In concentration terms, suitable application rates are generally about 0.001% to about 2% Si, for example about 0.01% to about 1% or about 0.05% to about 0.5% Si, illustratively about 0.05%, about 0.06%, about 0.1%, about 0.12%, about 0.15%, about 0.18%, about 0.2%, about 0.25%, about 0.3%, about 0.36%, about 0.4% or about 0.5% Si. In area terms, suitable application rates are generally about 0.05 to about 2 kg/ha Si, for example about 0.1 to about 1 kg/ha Si, illustratively about 0.1, about 0.12, about 0.15, about 0.2, about 0.25, about 0.3, about 0.4, about 0.5, about 0.6, about 0.75, about 0.8 or about 1 kg/ha Si.

The frequency of application can also be varied depending on the factors mentioned above. It will often be found advantageous to apply a relatively high “starter” rate, followed by subsequent applications at a lower rate. Application frequency can be, for example, twice daily to once monthly, more typically once daily to twice monthly, illustratively once a day or at intervals of 2, 3, 4, 5, 7, 10 or 14 days. In certain situations, a single application will suffice.

Methods as described in detail above are useful for silicon nutrition of a plant. Any benefit of enhanced Si nutrition can be a benefit of the present methods, including without limitation higher quality produce, improved growth and/or a longer growing season (which in either case can lead to higher yield of produce), improved plant stress management including increased stress tolerance and/or improved recovery from stress, increased mechanical strength, improved root development, improved drought resistance and improved plant health.

In various embodiments, yield of produce can be increased, for example by at least about 2%, at least about 4%, at least about 6%, at least about 8%, at least about 10%, at least about 15%, at least about 25% or at least about 50%, over plants not receiving a Si nutrient treatment.

Improved plant health, particularly resistance to or protection from disease, especially bacterial or fungal disease, is an important benefit of methods of the invention. In one embodiment, a method is provided for reducing susceptibility of a plant to fungal or bacterial disease. “Reduced susceptibility” herein includes reduced incidence of fingal or bacterial infection and/or reduced impact of such infection as occurs on the health and growth of the plant. It is believed, without being bound by theory, that the enhanced Si nutrition afforded by compositions of the invention strengthens the plant's natural defenses against fungal and bacterial pathogens. Examples of such pathogens include, without limitation, Alternaria spp., Blumeria graminis, Botrytis cinerea, Cochliobolus miyabeanus, Colletotrichum gloeosporioides, Diflocarpon rosae, Fusarium oxysporum, Magnaporthe grisea, Magnaporthe salvinii, Phaeosphaeria nodorum, Pythium aphanidermatum, Pythium ultimum, Sclerotinia homoeocarpa, Septoria nodorum, Sphaerotheca pannosa, Sphaerotheca xanthii, Thanatephorus cucumeris and Uncinula necator.

A single species of pathogen can cause a variety of different diseases in different crops. Examples of bacterial and fungal diseases of plants include, without limitation, anthracnose, armillaria, ascochyta, aspergillus, bacterial blight, bacterial canker, bacterial speck, bacterial spot, bacterial wilt, bitter rot, black leaf, blackleg, black rot, black spot, blast, blight, blue mold, botrytis, brown rot, brown spot, cercospora, charcoal rot, cladosporium, clubroot, covered smut, crater rot, crown rot, damping off, dollar spot, downy mildew, early blight, ergot, erwinia, false loose smut, fire blight, foot rot, fruit blotch, fusarium, gray leaf spot, gray mold, heart rot, late blight, leaf blight, leaf blotch, leaf curl, leaf mold, leaf rust, leaf spot, mildew, necrosis, peronospora, phoma, pink mold, powdery mildew, rhizopus, root canker, root rot, rust, scab, smut, southern blight, stem canker, stem rot, verticillium, white mold, wildfire and yellows.

### Examples

### Example 1

### Movement of Si from Foliarly Applied Materials into Leaf Tissue of Rice

Seeds of lsil mutant rice (low silicon rice 1, deficient in active Si uptake) were surface sterilized in 10% NaOCl for 1.5 min, rinsed in sterilized water for 3 min, and germinated on distilled water-soaked germitest paper in a germination chamber at 25° C. for 6 days. Germinated seedlings were transferred to plastic containers with one-half-strength nutrient solution for two days. After this period, plants were transferred to new plastic containers with fall-strength nutrient solution. The nutrient solution, without aeration, was changed every 4 days. The pH was checked daily and kept at approximately 5.5 by using NaOH or HCl (1 M) when needed. The nutrient solution used in this study was composed of 1.0 mM KNO₃, 0.25 mM NH₄PO₄, 0.1 mM NH₄Cl, 0.5 mM MgSO₄.7H₂O, 1.0 mM Ca(NO₃)₂.4H₂O, 0.3 μM CuSO₄.5H₂O, 0.33 μM ZnSO₄.7H₂O, 11.5 μM H₃BO₃, 3.5 μM MnCl₂.4H₂O, 0.1 μM (NH₄)₆Mo₇O₂₄, 25 μM FeSO₄.7H₂O and 25 μM EDTA bisodic. This nutrient solution was Si-free.

The trial consisted of five foliar spray treatments:
A. 3.7% Si, 10.0% TKPP, 7.5% potassium thiosulfate, plus organic mixture (see below)
B. 3.7% Si, 33.2% potassium thiosulfate, plus organic mixture (see below)
C. 3.7% Si, 33.2% potassium thiosulfate
D. 9.9% Si as potassium silicate (FertiSil®; PQ Corporation Ltda, Brazil)
E. control (sterile deionized water)

The amount of organic mixture included in compositions A and B of the invention is equivalent to about 10% KAFÉ™-F foliar solution (Floratine Biosciences, Inc.) or, in the 2% spray solutions prepared as described below, about 0.2% KAFÉ™-F foliar solution.

The trial was arranged in a completely randomized design with five replications. Each experimental unit consisted of one plastic container with 5 liters of nutrient solution and four rice plants. The experiment was repeated once. Compositions A-E were applied to all leaves of each plant as foliar sprays, in the case of A-D at 2% by volume concentration. Leaves of rice plants at the second leaf tiller growth stage were sprayed using a DeVilbiss No. 15 atomizer. The base of the plants was covered during spraying to prevent run-off of the sprayed materials into the nutrient solution.

Leaves of plants from all treatments were collected 24 hours after spraying. One-half was gently washed in sterile deionized water for 10 min to potentially remove any Si deposited on the sprayed leaf surface and then analyzed for Si content as described by Elliott & Snyder (1991) J. Agric. Food Chem. 39:1118-1119. Data for Si content of leaf tissue was subjected to ANOVA and means were tested for significant differences (P=0.05) using Tukey's test. Cochran's test for homogeneity of variance indicated that data from Si content from the two experiments could be pooled; therefore, data from the two trials were pooled for data analysis.

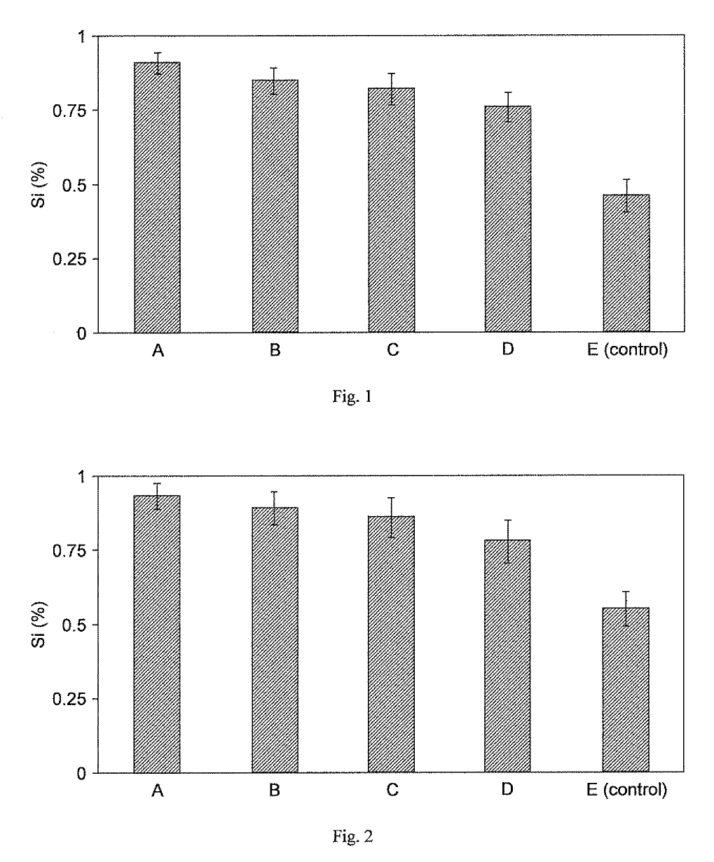

The Si content in leaf tissue was as shown in FIG. 1. Si content was significantly (P≦0.05) increased by 98%, 85%, 78% and 65% by compositions A, B, C and D respectively compared to control. Plants sprayed with composition A of the invention showed an increase of 20%, and plants sprayed with composition B of the invention showed an increase of 12%, in Si content compared to plants sprayed with potassium silicate (composition D). This is in spite of the fact that the Si content of composition D was 2.67 times greater than for compositions A and B.

### Example 2

### Movement of Si from Foliarly Applied Materials into Leaf Tissue of Rice

Rice lsil mutant seedlings were grown exactly as in Example 1, using the same nutrient solution. The trial consisted of ten foliar spray treatments, with compositions A-E as described in Example 1, each sprayed once, or twice with the second spraying 48 hours after the first.

The trial was arranged in a completely randomized design with five replications. Each experimental unit consisted of one plastic container with 5 liters of nutrient solution and four rice plants. The experiment was repeated once. Compositions A-E were applied to all leaves of each plant as foliar sprays, in the case of A-D at 2% by volume concentration. Spray treatments were applied once or twice, at an interval of 48 hours. The fourth leaf on the four tillers per plant, including the main tiller, were sprayed using a DeVilbiss No. 15 atomizer. The other leaves of the plants were protected during spraying with a plastic bag. The base of the plants was covered during spraying to prevent run-off of the sprayed materials into the nutrient solution. The fourth (sprayed) leaf from plants that received all treatments were removed 24 hours after each spray. One-half was gently washed in sterile deionized water for 10 min to potentially remove any Si deposited on the sprayed leaf surface, and then analyzed for Si content as described by Elliott & Snyder (1991), supra. Data for Si content of leaf tissue was subjected to ANOVA and means were tested for significant differences (P=0.05) using Tukey's test. Cochran's test for homogeneity of variance indicated that the data from Si content from the two experiments could be pooled; therefore, data from the two trials were pooled for data analysis.

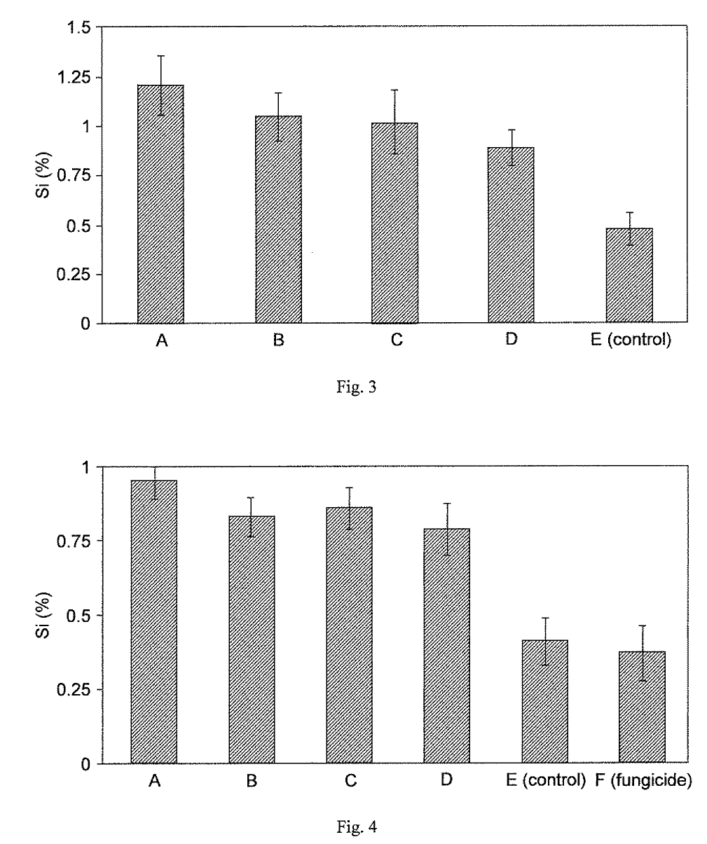

The Si content in leaf tissue was as shown in FIGS. 2 and 3, for plants sprayed once and twice respectively. In plants sprayed once, Si content was significantly (P≦0.05) increased by 69%, 62%, 56% and 42% by compositions A, B, C and D respectively compared to control. In plants sprayed twice, Si content was significantly (P≦0.05) increased by 152%, 119%, 113% and 85% by compositions A, B, C and D respectively compared to control.

Plants sprayed once with composition A of the invention showed an increase of 19%, and plants sprayed once with composition B of the invention showed an increase of 14%, in Si content compared to plants sprayed once with potassium silicate (composition D). Plants sprayed twice with composition A of the invention showed an increase of 36%, and plants sprayed twice with composition B of the invention showed an increase of 18%, in Si content compared to plants sprayed twice with potassium silicate (composition D). This is in spite of the fact that the Si content of composition D was 2.67 times greater than for compositions A and B.

### Example 3

### Effect of Foliar Application of Si Compositions on Brown Spot of Rice

Rice lsil mutant seedlings were grown exactly as in Example 1, using the same nutrient solution. The trial consisted of six foliar spray treatments, with compositions A-E as described in Example 1 and with composition F: fungicide (diphenoconazole, 1.5 ml/liter).

The trial was arranged in a completely randomized design with five replications. Each experimental unit consisted of one plastic container with 5 liters of nutrient solution and four rice plants. The experiment was repeated once. Compositions A-F were applied to rice leaves as foliar sprays 24 hours before inoculation with the brown spot pathogen Bipolaris oryzae. Solutions of compositions A-D were prepared at 2% concentration. The fungicide (composition F) was prepared at 1.5 ml/liter concentration. Plants at the fifth leaf tiller growth stage were sprayed using a DeVilbiss No. 15 atomizer. The base of the plants was covered during spraying to prevent run-off of the sprayed materials into the nutrient solution.

A pathogenic isolate of B. oryzae (CNPAF-HO 82), obtained from symptomatic rice plants, was used to inoculate the plants. A conidial suspension of B. oryzae (5×10³ conidia/ml) was applied as a fine mist to the adaxial leaf blades of each plant until runoff using a VL Airbrush atomizer (Paasche Airbrush Co., Chicago, Ill.). Immediately after inoculation, plants were transferred to a mist chamber at 25±2° C. with an initial 24 h dark period. After this 24 h period, plants were incubated using a 12 h photoperiod of approximately 162 μE m⁻² s⁻¹ provided by cool-white fluorescent lamps. Plants were kept inside the mist chamber for the duration of the experiments.

Brown spot severity on leaves of each plant was scored at 24, 48, 72 and 96 hours after inoculation using an International Rice Research Institute (IRRI) scale based on the percentage of diseased leaf area. Area under brown spot progress curve (AUBSPC) for each leaf in each plant was computed using the trapezoidal integration of brown spot progress curve over time using the formula proposed by Shaner & Finney (1977) Phytopathol. 67:1051-1056. After the experiment, leaves were collected and analyzed for Si content as described by Elliott & Snyder (1991), supra. Data for Si content on leaf tissue and AUBSPC was subjected to ANOVA and means were tested for significant differences (P=0.05) using Tukey's test. Cochran's test for homogeneity of variance indicated that the data from Si content and AUBSPC from the two experiments could be pooled; therefore, data from the two trials were pooled for data analysis.

The Si content in leaf tissue was as shown in FIG. 4. Si content was significantly (P≦0.05) increased by 132%, 102%, 110% and 93% by compositions A, B, C and D respectively compared to control. Plants sprayed with composition A of the invention showed an increase of 20%, and plants sprayed with composition B of the invention showed an increase of 5%, in Si content compared to plants sprayed with potassium silicate (composition D). This is in spite of the fact that the Si content of composition D was 2.67 times greater than for compositions A and B.

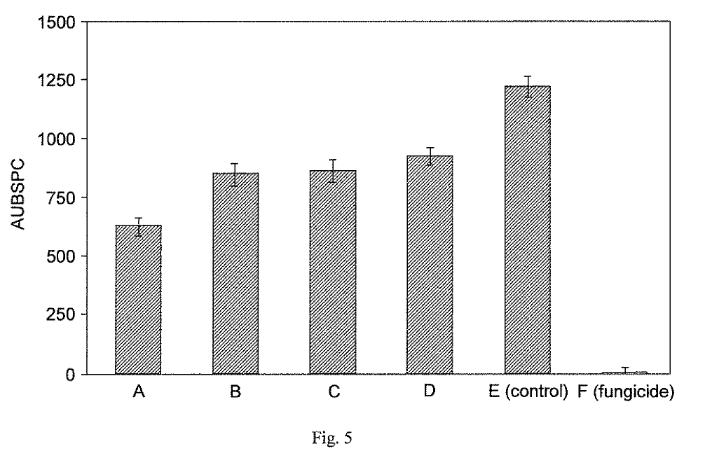

AUBSPC data are shown in FIG. 5. Plants sprayed with composition A of the invention showed a decrease of 49% in AUBSPC, and plants sprayed with composition B of the invention showed a decrease of 30% in AUBSPC, compared to control. By contrast, plants sprayed with potassium silicate (composition D) showed a decrease of only 24% in AUBSPC, compared to control. Again, this is in spite of the fact that the Si content of composition D was 2.67 times greater than for compositions A and B.

The number and size of necrotic lesions were greatly reduced on leaves of plants sprayed with compositions A, B and C, compared to control. Indeed, on those leaves, fewer lesions coalesced, and the intensity of chlorosis was reduced. There was complete absence of lesions on leaves of plants sprayed with fungicide (composition F). Lesions formed on leaves of plants sprayed with potassium silicate (composition D) were more numerous and bigger, and were surrounded by a very well-developed chlorotic halo, and had intense necrotic tissue compared to leaves from plants sprayed with compositions A, B and C.

All patents and publications cited herein are incorporated by reference into this application in their entirety.

The words “comprise”, “comprises”, and “comprising” are to be interpreted inclusively rather than exclusively.

What is claimed is:

1. A foliarly applicable plant nutrient composition comprising, in aqueous solution:
(a) a first component comprising an agriculturally acceptable source of foliarly absorbable silicon;
(b) a second component selected from agriculturally acceptable sources of thiosulfate ions, agents effective to inhibit polymerization of silicic acid or silicate ions, and mixtures thereof, and
(c) as a third component, an agriculturally acceptable mixture of compounds selected from the group consisting of organic acids, organic compounds having functional groups capable of reversibly binding or complexing with inorganic anions, and mixtures thereof.

2. The composition of claim 1, wherein the first component comprises an alkali metal silicate salt.

3. The composition of claim 1, wherein the first component comprises potassium silicate.

4. The composition of claim 1, wherein the second component comprises a water-soluble thiosulfate salt.

5. The composition of claim 4, wherein the thiosulfate salt is potassium thiosulfate.

6. The composition of claim 1, wherein the third component comprises humic substances.

7. The composition of claim 1, wherein the third component comprises one or more compounds selected from polyamines, carbonyl compounds, polysaccharides, sugar alcohols and mixtures thereof.

8. The composition of claim 1, wherein the compounds of the third component have molecular weights in a range from about 300 to about 18,000 daltons.

9. The composition of claim 8, wherein collectively in the mixture of compounds
(a) about 25% to about 40% of carbon is in carboxy and carbonyl groups, about 20% to about 45% of carbon is in aromatic groups, about 10% to about 30% of carbon is in aliphatic groups and about 10% to about 30% of carbon is in acetal and other heteroaliphatic groups; and
(b) the mixture of compounds comprises, by elemental weight, about 28% to about 55% C, about 3% to about 5% H, about 30% to about 50% O, about 0.2% to about 3% N and about 0.2% to about 4% S.

10. The composition of claim 1, further comprising at least one agriculturally acceptable source of a plant nutrient other than silicon.

11. The composition of claim 10, wherein the at least one plant nutrient source comprises a phosphorus source.

12. The composition of claim 11, wherein the phosphorus source comprises tetrapotassium pyrophosphate.

13. The composition of claim 1, in a form of a concentrate formulation suitable for dilution to prepare a solution for application to plant foliage.

14. The composition of claim 13, comprising about 0.1 % to about 10% by weight Si.

15. The composition of claim 13, comprising about 1% to about 8% by weight Si.

16. The composition of claim 13, comprising, as the first component, about 5% to about 20% potassium silicate, as the second component, about 2% to about 35% by weight potassium thiosulfate and, as the third component, at least about 1 part by weight per 1000 parts by weight Si of a mixture of organic compounds or supramolecular aggregates wherein
(a) the compounds or aggregates have molecular weights in a range from about 300 to about 18,000 daltons;
(b) about 25% to about 40% of carbon is in carboxy and carbonyl groups, about 20% to about 45% of carbon is in aromatic groups, about 10% to about 30% of carbon is in aliphatic groups and about 10% to about 30% of carbon is in acetal and other heteroaliphatic groups; and
(c) the mixture of compounds comprises, by elemental weight, about 28% to about 55% C, about 3% to about 5% H, about 30% to about 50% O, about 0.2% to about 3% N and about 0.2% to about 4% S.

17. The composition of claim 16, further comprising about 2% to about 30% by weight tetrapotassium pyrophosphate.

18. The composition of claim 1, in a form of a solution suitable for application to plant foliage without further dilution.

19. The composition of claim 18, comprising about 0.001% to about 2% by weight Si.

20. The composition of claim 18, comprising about 0.01% to about 1% by weight Si.

21. A method for silicon nutrition of a plant, comprising applying a composition of claim 1 to a foliar surface of the plant.

22. The method of claim 21, wherein the plant is a food crop.

23. The method of claim 21, where the plant is a non-gramineous crop.

24. The method of claim 21, wherein the plant is a fruit or vegetable crop.

25. The method of claim 21, wherein the composition is prepared by diluting a concentrate formulation in water and the diluted formulation is applied by spraying to the foliar surface.

26. The method of claim 21, wherein the composition is applied at a Si concentration of about 0.001% to about 2% by weight.

27. The method of claim 21, wherein the composition is applied at a rate providing about 0.05 to about 2 kg Si/ha.

28. A method for reducing susceptibility of a plant to fungal or bacterial disease, comprising applying a composition of claim 1 to a foliar surface of the plant.

29. The method of claim 28, wherein the plant is a food crop.

30. The method of claim 28, where the plant is a non-gramineous crop.

31. The method of claim 28, wherein the plant is a fruit or vegetable crop.

32. The method of claim 28, wherein the composition is prepared by diluting a concentrate formulation in water and the diluted formulation is applied by spraying to the foliar surface.

33. The method of claim 28, wherein the composition is applied at a Si concentration of about 0.001% to about 2% by weight.

34. The method of claim 28, wherein the composition is applied at a rate providing about 0.05 to about 2 kg Si/ha.
